(19) United States
(12) Patent Application Publication
(10) Pub. No.: US 2004/0185336 A1
(43) Pub. Date: Sep. 23, 2004

(54) All solid-state thin-film cell and application thereof

(75) Inventors: Shuji Ito, Nara-shi (JP); Masaya Ugaji, Osaka (JP); Shinji Mino, Osaka (JP); Junichi Inaba, Osaka (JP)

Correspondence Address: MCDERMOTT, WILL & EMERY, 600 13th Street, N.W., WASHINGTON, DC, 20005-3096, US

(73) Assignee: MATSUSHITA ELECTRIC INDUSTRIAL CO., LTD.

(21) Appl. No.: 10/778,168

(22) Filed: Feb. 17, 2004

(30) Foreign Application Priority Data
Feb. 18, 2003 (JP) JP2003-039617

(51) Int. Cl. H01M 6/46; H01M 2/24

(52) U.S. Cl. 429/152; 429/160; 429/162

(57) ABSTRACT

An all solid-state thin-film cell, comprising stacked plural power generating elements, where the plural power generating elements are connected in series or in parallel, each of the plural power generating elements comprises a first current collector, a first electrode, a solid electrolyte, a second electrode and a second current collector, which are successively stacked in this order, and a buffer layer is interposed between at least one pair of the power generating elements.

### BACKGROUND OF THE INVENTION

With advance in size and weight reduction of electronic and electric appliances, a demand has been increasing for size and weight reduction of electrochemical cells. Meanwhile, currently used lithium-ion batteries, lithium-polymer batteries and all solid-state batteries have been being fabricated through a step of coating a material or a step of forming a pellet, causing an electrode mixture layer and an electrolyte layer in each fabricated cell to have a thickness of several dozens to several hundreds micrometers (μm), and there is therefore a limit to size and weight reduction of those cells.

Further, as for all solid-state cells comprising a thick electrode mixture layer and a thick electrolyte layer, a desired capacity and rate performance can be obtained only when a solid electrolyte is mixed into the electrode mixture layer in an amount abundant enough to be brought into sufficient contact with active material particles, and there is therefore a limit to an increase in energy density.

Under such circumstances, studies have been conducted on an ultra small and thin cell, developed by combination of a thin-film technology and a cell material technology, for fulfilling the aforementioned demand. An ultra small and thin cell has promise as a power source of integrated circuit (IC) cards, electric tags or the like, and has been expected to be mountable onto large-scale integrated circuit (LSI) boards.

Also under development is an all solid-state thin-film cell comprising a solid electrolyte, a lithium composite oxide such as LiCoO₂ as a positive electrode, and metallic lithium as a negative electrode. An all solid-state thin-film cell is fabricated as introducing a sputtering method, a vapor deposition method and the like, which are used in the semiconductor production process, and a patterning method. The introduction of such methods has led to development of an all solid-state thin-film cell comprising an electrode mixture layer and a solid electrolyte layer, each having a thickness of 10 μm or smaller (e.g. Japanese Laid-Open Patent Publication No. Sho 61-165965, Japanese Laid-Open Patent Publication No. Hei 6-153412, Japanese Laid-Open Patent Publication No. Hei 10-284130 and Japanese Laid-Open Patent Publication No. 2000-106366). Further, in an attempt to achieve high voltage and capacity while not practically increasing a cell area, a stacked cell has been studied in which all solid-state thin-film cells are stacked in a vertical direction and then connected in series or parallel (e.g. Japanese Laid-Open Patent Publication No. Hei 6-231796, Japanese Laid-Open Patent Publication No. 2002-42863 and U.S. Pat. No. 5,612,152).

However, a thin film, produced by means of such vacuum processes as sputtering and vapor deposition, possesses film stress, and as plural thin films are stacked, a problem may arise that the films peel from each other when handled during or after the film production process. Further, even in a cell fabricated with no occurrence of peeling of thin films, interfacial attachment is insufficient due to the film stress. Hence, when charge/discharge cycles are repeated, thin films may peel from each other owing to expansion and shrinkage of an electrode mixture layer in charging/discharging, thereby decreasing cell capacity.

### BRIEF SUMMARY OF THE INVENTION

In view of the aforementioned problem, it is an object of the present invention to provide an all solid-state thin-film cell that excels in alleviating film stress generated in a film production process to reduce a cell defective ratio, and also excels in charge/discharge cycle characteristic.

The present invention relates to an all solid-state thin-film cell, comprising stacked plural power generating elements, where the plural power generating elements are connected in series or in parallel, each of the plural power generating elements comprises a first current collector, a first electrode, a solid electrolyte, a second electrode and a second current collector, which are successively stacked in this order, and a buffer layer is interposed between at least one pair of the power generating elements.

The thickness of the buffer layer is, for example, not smaller than 0.01 μm and not larger than 5 μm.

It is preferable that the buffer layer comprise a metal and/or a resin.

When the plural power generating elements are connected in series, a first terminal connected to the first current collector and a second terminal connected to the second current collector can respectively be disposed on the top surface and the under surface of the stacked plural power generating elements. However, the positions of the first terminal and the second terminal are not limited to those surfaces.

When the plural power generating elements are connected in parallel, a first terminal connected to the first current collector and a second terminal connected to the second current collector can respectively be disposed on one side face and the opposite side face to the one side face of the stacked plural power generating elements. However, the positions of the first terminal and the second terminal are not limited to those side faces.

It is preferable that the all solid-state thin-film cell have a rectangular outer shape with each side of 20 mm or longer, and a thickness of 2 mm or smaller.

The present invention further relates to a circuit board and a portable terminal that carry the aforementioned all solid-state thin-film cell.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical sectional view of an all solid-state thin-film cell in accordance with Embodiment 1 of the present invention.

FIG. 2 is a top plan view of the all solid-state thin-film cell in accordance with Embodiment 1 of the present invention.

FIG. 3 is a vertical sectional view of an all solid-state thin-film cell in accordance with Embodiment 2 of the present invention.

FIG. 4 is a top plan view of the all solid-state thin-film cell in accordance with Embodiment 2 of the present invention.

FIG. 5 is a vertical sectional view of an all solid-state thin-film cell in accordance with Example 3 of the present invention.

FIG. 6 is a vertical sectional view of an all solid-state thin-film cell in accordance with Example 4 of the present invention.

### DETAILED DESCRIPTION OF THE INVENTION

An all solid-state thin-film cell of the present invention comprises stacked plural power generating elements and a buffer layer interposed between at least one pair of the power generating elements. Each of the plural power generating elements comprises a first current collector, a first electrode, a solid electrolyte, a second electrode and a second current collector, which are all thin films and successively stacked. With a buffer layer disposed between a pair of the power generating elements comprising the thin films as thus described, it is possible to absorb or alleviate film stress of the pair of the current collectors in contact with the buffer layer. It is also possible to inhibit peeling of the thin films from each other in cell fabrication, thereby improving a cell fabrication yield. Further, even when the electrode layer expands and shrinks in charging/discharging of the cell, interfacial attachment is resistant to breaking by the action of the buffer layer. It is therefore possible to fabricate an all solid-state thin-film cell with high capacity and an excellent charge/discharge cycle characteristic.

The all solid-state thin-film cell provided with the buffer layer therein resists damage even when bent, and hence, the cell is suitable for being mounted on or implemented in a flexible circuit board. Examples of such a circuit board may include an IC board and an LSI board.

Further, the all solid-state thin-film cell in accordance with the present invention resists damage even when bent, and the cell is thus suited for use in a thin portable terminal or personal digital assistance. Examples of such a thin portable terminal or personal digital assistance may include an IC card and an IC tag.

The present invention is particularly effective when an all solid-state thin-film cell has a rectangular outer shape with each side of 20 mm or longer, and a thickness of 2 mm or smaller.

In the following, exemplary embodiments of the present invention are described.

Embodiment 1

In the present embodiment, an example is presented in which plural power generating elements are connected in parallel.

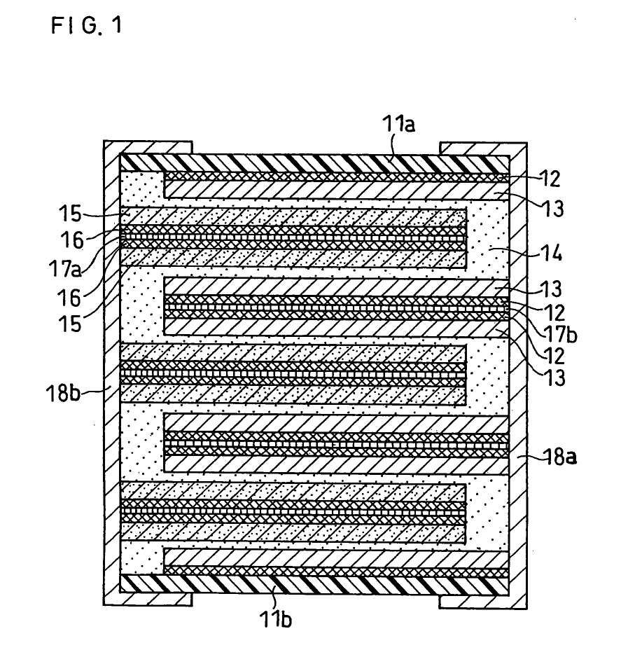

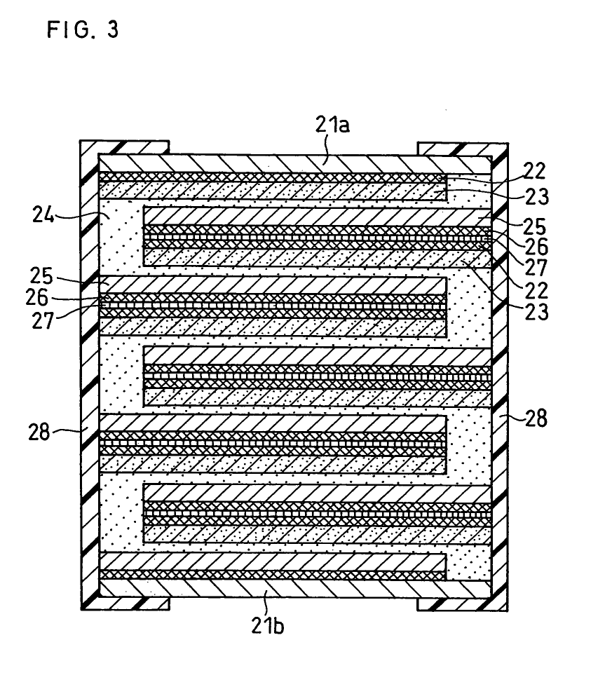

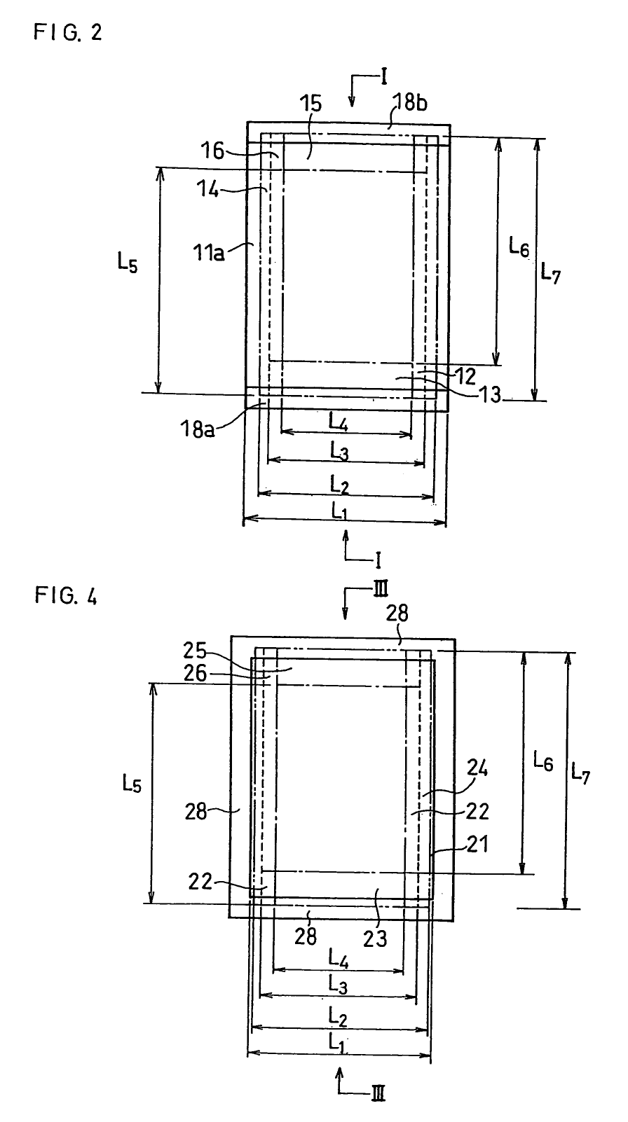

FIG. 1 shows a vertical sectional view of an all solid-state thin-film cell in accordance with the present embodiment. FIG. 2 shows a top plan view of the same cell. FIG. 1 corresponds to a sectional view taken on a line I-I of FIG. 2.

In FIG. 1, a first current collector 12, a first electrode 13, a solid electrolyte 14, a second electrode 15, a second current collector 16, a buffer layer 17a, a second current collector 16 . . . are successively stacked on a substrate 11a serving as a protection layer. The successive stacking ends with a first current collector 12, the top surface of which is covered with a substrate 11b serving as a protection layer. The substrate 11b does not necessarily exist.

Each of the first current collectors 12 is connected to a first terminal 18a disposed on one side face (the right side in FIG. 1) of the stacked power generating elements; each of the second current collectors 16 is connected to a second terminal 18b disposed on the opposite side face (the left side in FIG. 1) of the stacked power generating elements. The remaining two side faces are preferably sealed with an insulating material such as a resin.

The formation of the external terminals on the side faces in this manner simplifies the terminal structure, enabling fabrication of an all solid-state thin-film cell with an excellent volume utilization rate, high capacity and a high energy density. Moreover, the use of such an all solid-state thin-film cell allows production of a circuit board and a portable terminal that have excellent mounted area efficiency.

Next, an explanation is given to a method for fabricating an all solid-state thin-film cell of the kind thus described, with reference to FIGS. 1 and 2. It is to be noted that what is explained here is an instance of a lithium secondary battery comprising a first electrode as a negative electrode.

(i) Film Formation of First Current Collector

First, as shown in FIG. 2, a first current collector 12 is formed in a region represented with a width L₃ and a length L₅ on the substrate 11a with a width L₁.

For the substrate 11a used can be substrates having electrical insulating properties, such as alumina, glass, a polyimide film, or a metal foil with an insulating layer formed on the surface thereof. The roughness of the substrate surface is preferably smaller, and a mirror board or the like is favorable.

For the first current collector used can be a material that has electrical conductivity and does not react with the first electrode. Examples of such a material may include platinum, platinum-palladium alloy, aluminum, nickel, copper, indium-tin oxide (ITO) and carbon materials.

The film of the first current collector can be formed by the use of a conventionally known thin-film formation process. For example, the top surface of the substrate 11a is covered with a mask having a window in form consistent with the region represented with the width L₃ and the length L₅, and the film of the aforementioned material is formed inside the window. As a method for use in the process of forming the first current collector, the following methods can be cited: chemical vapor deposition, sputtering, ion-beam deposition, electron-beam deposition, resistive heating deposition, and laser ablation. The preferable thickness of the first current collector is not smaller than 0.005 μm and not larger than 2 μm.

(ii) Film Formation of First Electrode

Next, as shown in FIG. 2, a negative electrode is formed as a first electrode 13 in a region represented with a width L₄ and a length L₅ on the first current collector 12. For the negative electrode, any material known as a material for a negative electrode of a lithium secondary battery can be used without restriction. For example, metallic lithium, amorphous carbon, graphite, nitrides such as Li₃₋ₐCoₐN, Li₃₋ₐNiₐN, and Li₃ₐMnₐN, oxides such as Nb₂O₅, SnO₂ and Fe₂O₃, metallic materials capable of absorbing and desorbing lithium, such as Al, Sn and Si, or alloy materials of those metallic materials, are preferably employed.

The film of the negative electrode can be formed by the use of a conventionally known thin-film formation process. For example, the top surface of the first current collector 12 is covered with a mask having a window in form consistent with the region represented with the width L₄ and the length L₅, and the film of the aforementioned material is formed inside the window. As a method for use in the process of forming the negative electrode, the following methods can be cited: chemical vapor deposition, sputtering, ion-beam deposition, electron-beam deposition, resistive heating deposition, and laser ablation.

It is to be noted that, because oxygen deficiency or nitrogen deficiency is apt to occur in forming a film of an oxide or a nitride, the substrate is preferably irradiated with oxygen plasma in the film formation. The irradiation of oxygen plasma is effective in preventing occurrence of oxygen deficiency or nitrogen deficiency in the first electrode. The preferable thickness of the first electrode is not smaller than 0.1 μm and not larger than 20 μm.

(iii) Film Formation of Solid Electrolyte

As shown in FIG. 2, a film of a solid electrolyte 14 is formed in a region represented with a width L₂ and a length L₇ so as to completely cover the first current collector 12 and the first electrode 13. For the solid electrolyte, it is preferable to use a material that has ion-conductivity and negligibly small electronic conductivity. In the present embodiment, a solid electrolyte having excellent lithium-ion conductivity is desirably used.

A material for the solid electrolyte having excellent lithium-ion conductivity may be exemplified by Li₃PO₄, LiPO₄₋ₓNₓ (LIPON) obtained by doping nitrogen into Li₃PO₄, vitreous sulfides such as Li₂S—SiS₂, Li₂S—P₂S₅ and Li₂S—B₂S₃, and a material obtained by doping lithium halide such as LiI or lithium oxyacid such as Li₃PO₄ into the vitreous sulfide.

The film of the solid electrolyte can be formed by the use of a conventionally known thin-film formation process. For example, the top surface of the first electrode 13 is covered with a mask having a window in form consistent with the region represented with the width L₂ and the length L₇, and the film of the aforementioned material is formed inside the window. As a method for use in the process of forming the solid electrolyte, the following methods can be cited: chemical vapor deposition, sputtering, ion-beam deposition, electron-beam deposition, resistive heating deposition, and laser ablation. The thickness of the solid electrolyte is not smaller than 0.1 μm and not larger than 10 μm.

(iv) Film Formation of Second Electrode

As shown in FIG. 2, a positive electrode is formed as a second electrode 15 in a region represented with a width L₄ and a length L₆ on the solid electrolyte 14. For the positive electrode, any material known as a material for a positive electrode of a lithium secondary battery can be used without restriction. Particularly preferred are lithium composite transition metal oxides such as lithium cobalt oxide (LiCoO₂), lithium nickel oxide (LiNiO₂) and lithium manganese oxide (LiMn₂O₄), oxides such as V₂O₅ and MoO₂, and sulfides such as TiS₂.

The film of the positive electrode can be formed by the use of a conventionally known thin-film formation process. For example, the top surface of the solid electrolyte 14 is covered with a mask having a window in form consistent with the region represented with the width L₄ and the length L₆, and the film of the aforementioned material is formed inside the window. As a method for use in the process of forming the positive electrode, the following methods can be cited: chemical vapor deposition, sputtering, ion-beam deposition, electron-beam deposition, resistive heating deposition, and laser ablation.

It is to be noted that the substrate is preferably irradiated with oxygen plasma in the film formation. The irradiation of oxygen plasma is effective in preventing occurrence of oxygen deficiency in the second electrode. The preferable thickness of the second electrode is not smaller than 0.1 μm and not larger than 20 μm.

(v) Film Formation of Second Current Collector

As shown in FIG. 2, a second current collector 16 is formed in a region represented with a width L₃ and a length L₆ on the second electrode 15. For the second current collector used can be a material that has electronic conductivity and does not react with the second electrode, as in the case of the first current collector. Examples of such a material may include platinum, platinum-palladium alloy, aluminum, nickel, copper, indium-tin oxide (ITO) and carbon materials.

The film of the second current collector can be formed by the use of a conventionally known thin-film formation process, as in the case of the first current collector. For example, the top surface of the second electrode 15 is covered with a mask having a window in form consistent with the region represented with the width L₃ and the length L₆, and the film of the aforementioned material is formed inside the window. As a method for use in the process of forming the second current collector, the following methods can be cited: chemical vapor deposition, sputtering, ion-beam deposition, electron-beam deposition, resistive heating deposition, and laser ablation. The preferable thickness of the second current collector is not smaller than 0.005 μm and not larger than 2 μm.

(vi) Film Formation of Buffer Layer

Next, a film of a buffer layer 17a is formed on the second current collector 16. The buffer layer preferably comprises a resin with high elasticity and/or a metal with high malleability and ductility.

A buffer layer comprising a resin can be formed for example by such a process as plasma polymerization of an organic monomer. Plasma polymerization proceeds as an organic monomer is put into a plasma state at a low temperature by glow discharge.

For example, the top surface of the second current collector 16 is covered with a mask having a window in form consistent with a region represented with a width L₃ and a length L₆ (the whole surface of the second current collector 16), and an organic monomer is put into a plasma state at a low temperature in a surrounding atmosphere, so that a prescribed thin film comprising a resin can be formed.

As an organic monomer capable of plasma polymerization used can be hydrocarbons such as ethane, ethylene, acetylene, propylene, butene, butadiene, cyclohexane, benzene and xylene, vinyl compounds such as acrylic acid, methyl acrylate, propionic acid, methyl methacrylate, allyl methacrylate and vinyl acetate, fluorocarbons such as tetrafluoroethylene and hexafluoropropylene, organic silane compounds such as hexamethyldisiloxane, hexamethyldisilane and tetramethyldisiloxane, and oxygen-containing monomers such as ethylene oxide and propylene oxide.

It is also possible to polymerize the aforementioned monomer for forming the film of the buffer layer by vaporizing the aforementioned organic monomer to be attached onto the face for the film formation and then irradiating the attached monomer with electron rays or ultraviolet rays.

Moreover, a buffer layer, comprising a metal with higher malleability and ductility than the current collector, such as gold or silver, can be formed by the resistive heating deposition method or the like. For example, the top surface of the second current collector 16 is covered with a mask having a window in form consistent with the region represented with the width L₃ and the length L₆ (the whole surface of the second current collector 16), and prescribed metal is deposited inside the window.

The thickness of the buffer layer is preferably 0.01 μm or larger in order to obtain the effect of alleviating film stress. The thicker the buffer layer, the higher the production yield thereof becomes because less thin films peel from each other. However, when a buffer layer is excessively thick, a cell energy density lowers; hence, the preferable thickness of the buffer layer is 5 μm or smaller.

Thereafter, a second current collector 16, a second electrode 15, a solid electrolyte 14, a first electrode 13 and a first current collector 12 are successively stacked by the same process as above described, and a buffer layer 17b is formed in the same manner as in the process (vi). Repetition of such an operation more than once allows fabrication of a desired stacked cell. After the film formation has been completed, an insulating substrate 11b is disposed on the finally formed film. As shown in FIG. 2, the side faces, where the ends of the first and second current collectors are exposed, are then covered with a conductive material to form a first terminal 18a and a second terminal 18b. As for the conductive material for use in forming those terminals, for example, a conductive paste produced by dispersing conductive particles in a resin can be used.

It should be noted that, although the buffer layer is formed between a pair of first current collectors and a pair of second current collectors in FIG. 1, the larger the number of buffer layers, the lower an energy density of a stacked cell becomes. It is therefore preferable that a buffer layer be formed only between a pair of first current collectors or between a pair of second current collectors, or a buffer layer be formed at intervals of several stacks, according to constituent materials, as well as the number of stacks, of a stacked cell so that an energy density can be prevented from lowering. Furthermore, in FIG. 1, the buffer layer 17a may be in contact with the first terminal 18a and the second terminal 18b when the buffer layer 17a comprises an insulating resin.

Embodiment 2

In the present embodiment, an example is presented in which plural power generating elements are connected in series.

FIG. 3 shows a vertical sectional view of an all solid-state thin-film cell in accordance with the present embodiment. FIG. 4 shows a top plan view of the same cell. FIG. 3 corresponds to a sectional view taken on a line III-III of FIG. 4. In FIG. 3, a first current collector 22, a first electrode 23, a solid electrolyte 24, a second electrode 25, a second current collector 26, a buffer layer 27, a first current collector 22, a first electrode 23 . . . are successively stacked on a substrate 21a serving as a protection layer and a first terminal. The successive stacking ends with a second current collector 26, which is covered with a substrate 21b serving as a protection layer and a second terminal. The four side faces of the stack are sealed with an insulating layer 28.

Next, an explanation is given to a method for fabricating an all solid-state thin-film cell of the kind thus described, with reference to FIGS. 3 and 4. It is to be noted that what is explained here is an instance of a cell comprising a first electrode as a positive electrode.

(i) Film Formation of First Current Collector

First, as shown in FIG. 4, a first current collector 22 is formed in a region represented with a width L₃ and a length L₅ on the substrate 21a with a width L₁.

For the substrate 21a used can be a semiconductor substrate of silicon or the like, a conductive substrate of aluminum, copper, stainless steel or the like, a resin film on which a conductive layer of metal or the like is formed, and other types of substrates. The roughness of the substrate surface is preferably smaller, and a mirror board or the like is favorable.

It is to be noted that the first current collector is not necessarily formed because the substrate 21a itself possesses conductivity. Herein, a raw material for the first current collector, a film formation method, film thickness and the like are the same as those in the case of the second current collector in Embodiment 1.

(ii) Film Formation of First Electrode

Next, as shown in FIG. 4, a positive electrode is formed as a first electrode 23 in a region represented with a width L₄ and a length L₅ on the first current collector 22. Herein, a raw material for the positive electrode, a film formation method, film thickness and the like are the same as those in the case of the second electrode in Embodiment 1.

(iii) Film Formation of Solid Electrolyte

As shown in FIG. 4, a film of a solid electrolyte 24 is formed in a region represented with a width L₂ and a length L₇ so as to completely cover the first current collector 22 and the first electrode 23. Herein, a raw material for the solid electrolyte, a film formation method, film thickness and the like are the same as those in the case of the solid electrolyte in Embodiment 1.

(iv) Film Formation of Second Electrode

As shown in FIG. 4, a negative electrode as a second electrode 25 is formed in a region represented with a width L₄ and a length L₆ on the solid electrolyte 24. Herein, a raw material for the negative electrode, a film formation method, film thickness and the like are the same as those in the case of the first electrode in Embodiment 1.

(v) Film Formation of Second Current Collector

As shown in FIG. 4, a second current collector 26 is formed in a region represented with a width L₃ and a length L₆ on the second electrode 25. Herein, a raw material for the second current collector, a film formation method, film thickness and the like are the same as those in the case of the first current collector in Embodiment 1.

(vi) Film Formation of Buffer Layer

Next, a film of a buffer layer 27 is formed on the whole surface of the second current collector 26. Herein, a raw material for the buffer layer, a film formation method, film thickness and the like are the same as those in the case of the buffer layer in Embodiment 1.

When plural power generating elements are connected in series as shown in FIG. 3, it is preferable that a metal and/or a conductive resin be used for the buffer layer from the perspective of simplifying the current collecting structure. However, when plural power generating elements are connected in series through the use of the side faces of a stacked cell, an insulating resin may be used for constituting the buffer layer.

Thereafter, a first current collector 22, a first electrode 23, a solid electrolyte 24, a second electrode 25, a second current collector 26 and a buffer layer 27 are successively stacked by the same process as above described. Repetition of such an operation more than once allows fabrication of a desired stacked cell. After the film formation has been completed, a conductive substrate 21b is disposed on the finally formed film. As shown in FIG. 4, the four side faces are covered with an insulating layer 28 comprising an insulating material. As for the insulating material, a resin can for example be used.

It should be noted that, although the buffer layer is formed between each first current collector and second current collector in FIG. 3, it is preferable that a buffer layer be formed at intervals of several stacks, according to constituent materials, as well as the number of stacks, of a stacked cell so that an energy density can be prevented from lowering. Furthermore, in FIG. 3, the buffer layer 27 may be in contact with the insulating layer 28 opposed thereto.

### EXAMPLE 1

In the present example, all solid-state thin-film cells were fabricated which had almost an equivalent structure to the cell illustrated in FIGS. 1 and 2 as described in Embodiment 1, and included a buffer layer comprising materials shown in Table 1. In the cells fabricated here, six power generating elements were connected in parallel, and a first electrode was a positive electrode.

(i) First Step

For the substrate 11a used was a surface-polished epoxy resin substrate. The top surface of this substrate was covered with a metal mask having a window with a width of 12 mm and a length of 20 mm. Subsequently, as shown in FIG. 2, a film of platinum with a thickness of 0.3 μm as the first current collector 12 was formed, by an rf magnetron sputtering method, in a 12 mm×20 mm region represented with a width L₃ and a length L₅.

(ii) Second Step

Next, the top surface of the first current collector 12 was covered with a metal mask having a window with a width of 10 mm and a length of 20 mm. Subsequently, as shown in FIG. 2, lithium cobalt oxide (LiCoO₂) was formed into a film with a thickness of 2 μm as the first electrode 13 in a 10 mm×20 mm region represented with a width L₄ and a length L₅.

The film of lithium cobalt oxide was formed by vaporizing lithium and cobalt under a 1×10⁻⁴ Torr atmosphere of a mixed gas containing 50% of Ar and 50% of oxygen. Herein, lithium having been put into a graphite-made pot and cobalt having been put into an alumina-made pot were separately used as deposition sources. Lithium and cobalt were vaporized by a resistive heating vapor deposition method (current: 100 A) and an electron-beam deposition method (electron accelerating voltage: 30 kV, emission current: 600 mA), respectively. At this time, the substrate surface was irradiated with energy with the use of a plasma gun (electron accelerating voltage: 50 V, electron current: 2 A, Ar flow rate: 7 sccm).

(iii) Third Step

Next, the top surface of the first electrode 13 was covered with a metal mask having a window with a width of 14 mm and a length of 25 mm. Subsequently, as shown in FIG. 2, LIPON (Li_{2.9}PO_{3.3}N_{0.46}) was formed into a film with a thickness of 2 μm as the solid electrolyte 14 in a 14 mm×25 mm region represented with a width L₂ and a length L₇.

The film of LIPON was formed by sputtering lithium phosphate (Li₃PO₄) using rf magnetron sputtering (applied electric power: 50 W) under a 1×10⁻² Torr atmosphere of nitrogen.

(iv) Fourth Step

Next, the top surface of the solid electrolyte 14 was covered with a metal mask having a window with a width of 10 mm and a length of 20 mm. Subsequently, as shown in FIG. 2, a film of lithium metal with a thickness of 0.5 μm as the second electrode 15 was formed, by resistive heating vapor deposition (degree of vacuum: 1×10⁻⁶ Torr), in a 10 mm×20 mm region represented with a width L₄ and a length L₆.

(v) Fifth Step

Next, the top surface of the second electrode 15 was covered with a metal mask having a window with a width of 12 mm and a length of 20 mm. Subsequently, as shown in FIG. 2, a film of platinum with a thickness of 0.3 μm as the second current collector 16 was formed, by rf magnetron sputtering, in a 12 mm×20 mm region represented with a width L₃ and a length L₆.

(vi) Sixth Step

Next, the top surface of the second current collector 16 was covered with a metal mask having a window with a width of 12 mm and a length of 20 mm. Subsequently, as shown in FIG. 2, materials “a” to “m” shown in Table 1 were formed into a film with a thickness of 1 μm as the buffer layer 17a in a 12 mm×20 mm region (the whole surface area of the second current collector 16) represented with a width L₃ and a length L₆.

In the case where the material used for the buffer layer was an organic monomer, the film of the buffer layer was formed by a plasma polymerization method. For example, when the organic monomer was ethane, conditions for plasma polymerization were an ethane-gas flow rate of 20 ml/minute, gas pressure of 0.1 Torr, discharge frequency of 13.56 MHz and discharge electric power of 25 W; when an organic monomer other than ethane was used, conditions for plasma polymerization were adjusted in such ranges as a gas flow rate of 10 to 50 ml/minute, gas pressure of 0.1 to 5 Torr, discharge frequency of 13.56 MHz and discharge electric power of 10 to 100 W.

When the material used for the buffer layer was metal, the film of the buffer layer was formed by resistive heating vapor deposition (degree of vacuum: 1×10⁻⁶ Torr).

Thereafter, a second current collector 16, a second electrode 15, a solid electrolyte 14, a first electrode 13 and a first current collector 12 were successively stacked by the same process as above described. By repetition of such an operation, six stacks of the power generating elements were stacked.

After the film formation had been completed, an epoxy resin was applied onto the finally formed film with a spin coater, and the coated film was heated at 150° C. so that an insulating substrate 11b with a thickness of 50 μm was disposed.

As shown in FIG. 2, the side faces, where the ends of the first and second current collectors were exposed, were then covered with a conductive paste containing silver powder to form a first terminal 18a and a second terminal 18b. In such a manner, 20 articles of each desired stacked cell were fabricated.

TABLE 1

| | Material for | Defective | Capacity maintenance |
|---|---|---|---|
| Battery | buffer layer | ratio(%) | ratio at 500^{th} cycle(%) |
| a | Ethane | 18 | 86 |
| b | Ethylene | 17 | 88 |
| c | Propylene | 19 | 85 |
| d | Butadiene | 15 | 87 |
| e | Benzene | 18 | 80 |
| f | Cyclohexane | 20 | 81 |
| g | Methyl acrylate | 9 | 92 |
| h | Methyl methacrylate | 8 | 93 |
| i | Vinyl acetate | 12 | 90 |
| j | Hexamethyldisiloxane | 13 | 89 |
| k | Propylene oxide | 17 | 82 |
| l | Gold | 21 | 87 |
| m | Silver | 22 | 85 |
| Com. Ex. 1 | None | 51 | 58 |

[Evaluation]

<Defective Ratio>

Each cell was repeatedly charged/discharged in a constant temperature bath at 20° C. The charging/discharging was conducted in a current mode of 0.013 mA/cm² with regard to electrode area. An-end-of-charge voltage was 4.2 V. An end-of-discharge voltage was 3.0 V. The charge/discharge cycles were repeated in the same conditions until the fourth cycle; the discharge current was changed to 0.13 mA/cm², and in this current mode, the charge/discharge cycles were repeated from the fifth cycle.

A defective ratio was determined such that a total number of defective cells was divided by 20 (number of fabricated cell articles), and the resultant value was expressed on percentage. The defective cells were those cells exhibiting the peeling of the thin films from each other in cell fabrication, and those cells exhibiting at the fourth cycle a discharge capacity smaller than 80% of a nominal capacity.

<Capacity Maintenance Ratio>

A capacity maintenance ratio was determined such that, among cells considered as non-defective, an average value of ratios of a discharge capacity at 500th cycle to a discharge capacity at fifth cycle was calculated, which was then expressed on percentage:

(Discharge capacity at 500th cycle÷Discharge capacity at fifth cycle)×100=Capacity maintenance ratio(%)

Table 1 shows defective ratios and capacity maintenance ratios.

### COMPARATIVE EXAMPLE 1

A cell was fabricated in the same manner as in Example 1, except that a buffer layer was not disposed, and then the cell was evaluated in the same manner as in Example 1.

As shown in Table 1, the cell of Comparative Example 1 exhibited a high defective ratio of 51% and a low capacity maintenance ratio of 58%, whereas the cells of Example 1 exhibited low defective ratios of 22% or lower and high capacity maintenance ratios of 80% or higher.

### EXAMPLE 2

Except that thickness of a buffer layer and the number of stacks of power generating elements were changed as shown in Table 2, cells were fabricated in the same manner as in Example 1. Specifically, stacked cells were fabricated in the same manner as in Example 1, which respectively comprised six stacks, 30 stacks and 100 stacks of power generating elements that were connected in parallel. For forming the buffer layer used herein was methyl acrylate. Conditions for plasma polymerization were the same as those in Example 1, and the buffer layer thickness was varied by controlling the time elapsed for plasma polymerization in the range of 0.5 to 30 minutes. Each cell was then evaluated in the same manner as in Example 1.

Table 2 shows defective ratios and capacity maintenance ratios.

TABLE 2

| Number of | Buffer layer | Defective | Capacity maintenance |
|---|---|---|---|
| stacks | thickness(μm) | ratio(%) | ratio at 500^{th} cycle(%) |
| 6 | 0 | 51 | 58 |
| | 0.005 | 40 | 63 |
| | 0.01 | 17 | 82 |
| | 0.1 | 13 | 89 |
| | 1 | 9 | 92 |
| | 2 | 8 | 94 |
| | 5 | 7 | 95 |
| | 7 | 7 | 94 |
| | 10 | 7 | 95 |
| 30 | 0 | 58 | 52 |
| | 0.005 | 48 | 55 |
| | 0.01 | 20 | 75 |
| | 0.1 | 15 | 84 |
| | 1 | 11 | 88 |
| | 2 | 10 | 90 |
| | 5 | 9 | 91 |
| | 7 | 9 | 90 |
| | 10 | 9 | 90 |
| 100 | 0 | 65 | 45 |
| | 0.005 | 52 | 49 |
| | 0.01 | 23 | 71 |
| | 0.1 | 19 | 80 |
| | 1 | 13 | 84 |
| | 2 | 11 | 86 |
| | 5 | 10 | 88 |
| | 7 | 10 | 88 |
| | 10 | 10 | 88 |

As shown in Table 2, a defective ratio of 25% or lower and a capacity maintenance ratio of 70% or higher were accomplished when the buffer layer thickness was 0.01 μm or larger. Further, with the buffer layer thickness not exceeding 5 μm, the larger the thickness, the lower the defective ratio became and the higher the capacity maintenance ratio became. From the viewpoint of the energy density, it is considered that the appropriate thickness of the buffer layer is not larger than 5 μm.

### EXAMPLE 3

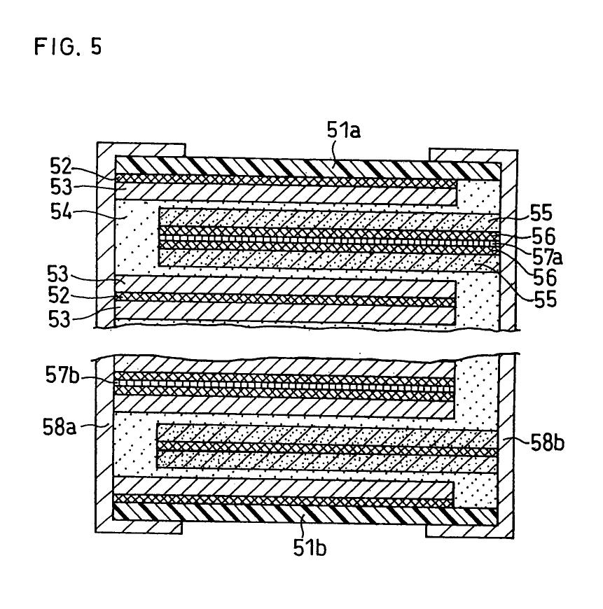

In the present example, as shown in FIG. 5, cells were fabricated in the same manner as in Example 1, except that a buffer layer 57a or 57b was formed at intervals of several stacks, the number of stacks of power generating elements was 100, and the kind of a buffer layer and the combination of a first electrode, a solid electrolyte and a second electrode were changed.

Specifically, a surface-polished epoxy resin substrate was used as a substrate 51a, and platinum was formed into a film with a thickness of 0.3 μm as a first current collector 52. Then, prescribed materials were formed into films as a first electrode 53, a solid electrolyte 54 and a second electrode 55, respectively. Subsequently, platinum was formed into a film with a thickness of 0.3 μm as a second current collector 56. Thereafter, a prescribed material was formed into a film with a thickness of 1 μm as the buffer layer 57a or 57b. After the film formation had been completed, an epoxy resin was applied onto the finally formed film with a spin coater, and the coated film was heated at 150° C. so that an insulating material layer 51b with a thickness of 50 μm was disposed. The side faces, where the ends of the first and second current collectors were exposed, were then covered with a conductive paste containing silver powder to form a first terminal 58a and a second terminal 58b.

Table 3 shows combinations of the first electrode, the solid electrolyte and the second electrode, a material used for the buffer layer, and the number of stacks between the buffer layers.

20 articles of each desired stacked cell were fabricated, and then evaluated in the same manner as in Example 1; however, a voltage range of charging/discharging was set as shown in Table 3.

Table 3 shows defective ratios and capacity maintenance ratios.

TABLE 3

| | | | | | Capacity |
|---|---|---|---|---|---|
| | | | | | maintenance |
| | Material for | | Defective | Voltage | ratio at 500^{th} |
| *A | buffer layer | *B | ratio(%) | range(V) | cycle(%) |
| LiCoO₂ | Methyl | 2 | 15 | 4.2-3.0 | 82 |
| LiPON | acrylate | 5 | 16 | | 80 |
| Li | | 10 | 17 | | 75 |
| | | 20 | 19 | | 72 |
| | None | None | 65 | | 45 |
| V₂O₅ | Methyl | 2 | 15 | 3.5-2.0 | 85 |
| LiPON | methacrylate | 5 | 15 | | 84 |
| Li | | 10 | 18 | | 82 |
| | | 20 | 20 | | 75 |
| | None | None | 60 | | 58 |
| LiCoO₂ | Propylene | 2 | 22 | 4.2-2.5 | 80 |
| LIPON | | 5 | 24 | | 78 |
| Carbon | | 10 | 27 | | 75 |
| material | | 20 | 29 | | 70 |
| | None | None | 60 | | 39 |
| LiMn₂O₄ | Butadiene | 2 | 19 | 2.7-1.5 | 82 |
| SSE | | 5 | 21 | | 80 |
| Li₄Ti₅O₁₂ | | 10 | 24 | | 77 |
| | | 20 | 27 | | 74 |
| | None | None | 58 | | 62 |
| V₂O₅ | Hexamethyl | 2 | 14 | 3.2-2.0 | 83 |
| LiPON | disiloxane | 5 | 17 | | 82 |
| Li_{2.6}Co_{0.4}N | | 10 | 18 | | 78 |
| | | 20 | 22 | | 72 |
| | None | None | 59 | | 61 |
| LiNiO₂ | Vinyl | 2 | 15 | 4.2-2.5 | 79 |
| SSE | acetate | 5 | 16 | | 75 |
| Si | | 10 | 17 | | 73 |
| | | 20 | 22 | | 70 |
| | None | None | 64 | | 55 |

*A First electrode
Solid electrolyte
Second electrode
*B Stack number between buffer layers

As shown in Table 3, in all the cells comprising the buffer layer, the defective ratios decreased and the cycle characteristics improved. Further, the cells comprising the buffer layer at intervals of 20 stacks exhibited maintenance ratios of 70% or higher at 500th cycle.

It is to be noted that a thin film (thickness: 2 μm) of lithium nickel oxide (LiNiO₂) or lithium manganese oxide (LiMn₂O₄) as the first electrode was formed by vaporizing lithium and nickel or manganese under a 1×10⁻⁴ Torr atmosphere of a mixed gas containing 50% of Ar and 50% of oxygen. Namely, lithium having been put into a graphite-made pot and nickel or manganese having been put into an alumina-made pot were separately used as deposition sources. Lithium was vaporized by resistive heating vapor deposition (current: 100 A) while nickel or manganese was vaporized by electron-beam vacuum deposition (electron accelerating voltage: 30 kV, emission current: 600 mA). At this time, the substrate surface was irradiated with energy with the use of a plasma gun (electron accelerating voltage: 50 V, electron current: 2 A, Ar flow rate: 7 sccm).

A thin film (thickness: 2 μm) of V₂O₅ as the first electrode was formed under a 1×10⁻⁴ Torr atmosphere of a mixed gas containing 50% of Ar and 50% of oxygen by electron-beam vacuum deposition (electron accelerating voltage 30 kV, emission current: 500 mA), using vanadium having been put into an alumina-made pot as a deposition source.

A thin film (thickness: 2 μm) of 0.63Li₂S-0.36SiS₂-0.01Li₃PO₄ (SSE) in a glassy state as the solid electrolyte was formed under a 20×10⁻³ Torr atmosphere of nitrogen by rf magnetron sputtering, using a mixture of Li₂S, SiS₂ and Li₃PO₄ in a mole ratio of 0.63:0.36:0.01 as a target.

A thin film (thickness: 1.5 μm) of carbon as the second electrode was formed under a 1×10⁻⁴ Torr atmosphere of Ar by electron-beam deposition (electron accelerating voltage: 40 kV, emission current: 10 mA), using a graphite tablet (manufactured by TOKAI CARBON CO.,LTD.) as a deposition source.

A thin film (thickness: 2 μm) of Li_{2.6}Co_{0.4}N as the second electrode was formed by vaporizing lithium and cobalt under a 1×10⁻⁴ Torr atmosphere of a mixed gas containing 50% of Ar and 50% of nitrogen. Namely, lithium having been put into a graphite-made pot and cobalt having been put into an alumina-made pot were separately used as deposition sources. Lithium was vaporized by resistive heating vapor deposition (current: 100 A) while cobalt was vaporized by electron-beam vacuum deposition (electron accelerating voltage: 30 kV, emission current: 600 mA). At this time, the substrate surface was irradiated with energy with the use of a plasma gun (electron accelerating voltage: 50 V, electron current: 2 A, Ar flow rate: 7 sccm).

A thin film (thickness: 2.2 μm) of Li₄Ti₅O₁₂ as the second electrode was formed under a 1×10⁻⁴ Torr atmosphere containing 50% of Ar and 50% of oxygen by rf magnetron sputtering (applied electric power: 50 W), using Li₄Ti₅O₁₂ as a target.

A thin film (thickness: 0.5 μm) of Si as the second electrode was formed under a 1×10⁻⁴ Torr atmosphere of Ar by rf magnetron sputtering (applied electric power: 60 W), using Si as a target.

Thin films of materials other than those described above were formed in the same manner as in Example 1.

### EXAMPLE 4

In the present example, all solid-state thin-film cell were fabricated which had almost an equivalent structure to the cell illustrated in FIGS. 3 and 4 as described in Embodiment 2, and included a buffer layer comprising materials shown in Table 4. In the cells fabricated here, six power generating elements were connected in series, and a first electrode was a positive electrode.

(i) First Step

For the substrate 21a used was a surface-polished stainless steel substrate. The top surface of this substrate was covered with a metal mask having a window with a width of 12 mm and a length of 20 mm. Subsequently, as shown in FIG. 4, a film of platinum with a thickness of 0.3 μm as the first current collector 22 was formed, by rf magnetron sputtering, in a 12 mm×20 mm region represented with a width L₃ and a length L₅.

(ii) Second Step

Next, the top surface of the first current collector 22 was covered with a metal mask having a window with a width of 10 mm and a length of 20 mm. Subsequently, as shown in FIG. 4, lithium cobalt oxide (LiCoO₂) was formed into a film with a thickness of 2 μm as the first electrode 23 in a 10 mm×20 mm region represented with a width L₄ and a length L₅. The film of lithium cobalt oxide was formed in the same manner as the first electrode in Example 1.

(iii) Third Step

Next, the top surface of the first electrode 23 was covered with a metal mask having a window with a width of 14 mm and a length of 25 mm. Subsequently, as shown in FIG. 4, LIPON (Li_{2.9} PO_{3.3}N_{0.46}) was formed into a film with a thickness of 2 μm as the solid electrolyte 24 in a 14 mm×25 mm region represented with a width L₂ and a length L₇. The film of LIPON was formed in the same manner as the solid electrolyte in Example 1.

(iv) Fourth Step

Next, the top surface of the solid electrolyte 24 was covered with a metal mask having a window with a width of 10 mm and a length of 20 mm. Subsequently, as shown in FIG. 4, a film of lithium metal with a thickness of 0.5 μm as the second electrode 25 was formed, by resistive heating vapor deposition, in a 10 mm×20 mm region represented with a width L₄ and a length L₆. The film of lithium metal was formed in the same manner as the second electrode in Example 1

(v) Fifth Step

Next, the top surface of the second electrode 25 was covered with a metal mask having a window with a width of 12 mm and a length of 20 mm. Subsequently, as shown in FIG. 4, a film of platinum with a thickness of 0.3 μm as the second current collector 26 was formed, by rf magnetron sputtering, in a 12 mm×20 mm region represented with a width L₃ and a length L₆.

(vi) Sixth Step

Next, the top surface of the second current collector 26 was covered with a metal mask having a window with a width of 12 mm and a length of 20 mm. Subsequently, as shown in FIG. 4, a material shown in Table 4 (gold or silver) was formed into a film with a thickness of 1 μm as the buffer layer 27 in a 12 mm×20 mm region (the whole surface area of the second current collector 26) represented with a width L₃ and a length L₆. The film of the buffer layer was formed in the same manner as the buffer layer in Example 1.

Thereafter, a first current collector 22, a first electrode 23, a solid electrolyte 24, a second electrode 25 and a second current collector 26 were successively stacked by the same process as above described. By repetition of such an operation, six stacks of the power generating elements were stacked.

After the film formation had been completed, a stainless steel substrate 21b was disposed on the finally formed film. As shown in FIGS. 3 and 4, an epoxy resin was applied onto the four side faces of the stack, which was then cured at 150° C. to form an insulating layer 28 with a thickness of 50 μm. In such a manner, 20 articles of each desired stacked cell were fabricated.

Moreover, as a cell for comparison, a cell comprising no buffer layer was also formed in almost the same manner as thus described.

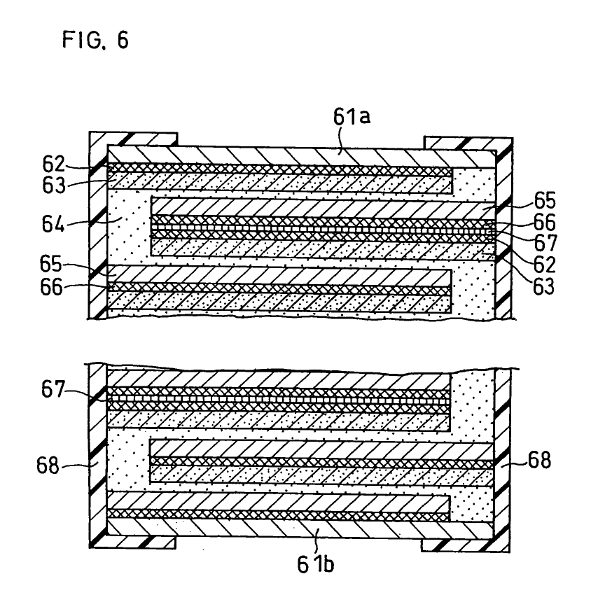

Furthermore, in the present example, cells were fabricated in the same manner as thus described, except that a buffer layer 67 was formed at intervals of several stacks and that thickness of a buffer layer and the number of stacks of power generating elements were changed, as shown in FIG. 6. Table 4 shows the number of stacks of power generating elements, a material used for the buffer layer, the thickness of the buffer layer, and the number of stacks between the buffer layers.

Herein, a surface-polished stainless steel substrate was used as a substrate 61a, and platinum was formed into a film with a thickness of 0.3 μm as a first current collector 62, lithium cobalt oxide was formed into a film with a thickness of 2 μm as a first electrode 63, LIPON was formed into a film with a thickness of 2 μm as a solid electrolyte 64, lithium metal was formed into a film with a thickness of 0.5 μm as a second electrode 65, platinum was formed into a film with a thickness of 0.3 μm as a second current collector 66, and gold or silver was formed into a film with a thickness of 0.5 μm or 0.01 μm as a buffer layer 67. After the film formation had been completed, a stainless steel substrate 61b was disposed on the finally formed film, and an insulating layer 68 with a thickness of 50 μm was disposed on the four side faces of the stack.

In such a manner, 20 articles of each desired stacked cell were fabricated. Those cells were evaluated in the same manner as in Example 1; however, based on the number of stacks (n), an end-of-charge voltage was (4.2×n) V and an end-of-discharge voltage was (3.0×n) V.

Table 4 shows defective ratios and capacity maintenance ratios.

TABLE 4

| Number of | Buffer layer | | Defective | Capacity maintenance |
|---|---|---|---|---|
| stacks | thickness(μm) | *A | ratio(%) | ratio at 500^{th} cycle(%) |
| 6 | Gold (1 μm) | 1 | 20 | 82 |
| | Silver (1 μm) | | 21 | 80 |
| | None | None | 50 | 45 |
| 10 | Gold (0.5 μm) | 2 | 23 | 78 |
| | Silver (0.5 μm) | | 23 | 75 |
| | None | None | 53 | 30 |
| 30 | Gold (0.01 μm) | 5 | 26 | 74 |
| | Silver (0.01 μm) | | 28 | 71 |
| | None | None | 60 | 21 |

*A Stack number between buffer layers

As shown in Table 4, cells comprising no buffer layer exhibited defective ratios of 50% or higher and capacity maintenance ratios of 45% or lower, whereas the cells of the present example exhibited improved defective ratios of 28% or lower and capacity maintenance ratios of 71% or higher.

As thus described, according to the present invention, there can be provided an all solid-state thin-film cell with an excellent charge/discharge cycle characteristic by forming a buffer layer between a pair of power generating elements to alleviate film stress and inhibit peeling of thin films from each other, and thereby to reduce a defective ratio.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An all solid-state thin-film cell, comprising stacked plural power generating elements, wherein
said plural power generating elements are connected in series or in parallel,
each of said plural power generating elements comprises a first current collector, a first electrode, a solid electrolyte, a second electrode and a second current collector, which are successively stacked in this order, and
a buffer layer is interposed between at least one pair of said power generating elements.

2. The all solid-state thin-film cell in accordance with claim 1, wherein said buffer layer has a thickness of not smaller than 0.01 μm and not larger than 5 μm.

3. The all solid-state thin-film cell in accordance with claim 1, wherein said buffer layer comprises a metal and/or a resin.

4. The all solid-state thin-film cell in accordance with claim 1,
said plural power generating elements being connected in series,
said cell further comprising a first terminal connected to said first current collector and a second terminal connected to said second current collector,
said first and second terminals being respectively disposed on the top surface and the under surface of said stacked plural power generating elements.

5. The all solid-state thin-film cell in accordance with claim 1,
said plural power generating elements being connected in parallel,
said cell further comprising a first terminal connected to said first current collector and a second terminal connected to said second current collector,
said first and second terminals being respectively disposed on one side face of said stacked plural power generating elements and on the opposite side face thereof to said one side face.

6. The all solid-state thin-film cell in accordance with claim 1, wherein said cell has a rectangular outer shape with each side of 20 mm or longer, and a thickness of 2 mm or smaller.

7. A circuit board carrying the all solid-state thin-film cell in accordance with claim 1.

8. A portable terminal carrying the all solid-state thin-film cell in accordance with claim 1.
